(19) United States
(12) Patent Application Publication
(10) Pub. No.: US 2001/0012239 A1
(43) Pub. Date: Aug. 9, 2001

(54) Electroacoustic transducer

(76) Inventor: Kazushige Tajima, Shizuoka (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/775,614

(22) Filed: Feb. 5, 2001

(30) Foreign Application Priority Data
Feb. 4, 2000 (JP) P. 2000-028257

(51) Int. Cl. H04R 25/00

(52) U.S. Cl. 367/155; 381/150

(57) ABSTRACT

An electroacoustic transducer 1 is configured by: a base 24 made of a magnetic material; a magnetic core 22 made of a magnetic material and upstanding from the base 24; a diaphragm 20 made of a magnetic material and spaced from the tip end of the magnetic core by a gap; a magnet 25 which cooperates with the base 24, the magnetic core 22 and the diaphragm 20 to constitute a magnetic circuit, and which supplies a static magnetic field; a coil 23 wound around the magnetic core 22, and supplying an oscillating magnetic field to the magnetic circuit; and a housing 30 formed integrally with the base 24 and the magnet 25. The housing 30 is interposed between the base 24 and the magnet 25, and the plan-view shape of the base 24 has a portion which elongates more outwardly than the width center of the magnet 25.

### BACKGROUND OF THE INVENTION

1. Field of the Invention

The present invention relates to an electroacoustic transducer which generates a sound by means of electroacoustic conversion.

2. Description of the Related Art

An electroacoustic transducer has a magnetic circuit in which a magnetic field from a magnet passes through a base member, a magnetic core, and a diaphragm and then returns to the magnet. When an oscillating electrical signal is supplied to a coil wound around the magnetic core, an oscillating magnetic field is generated by the coil and then superimposed on the static magnetic field of the magnetic circuit, and vibration of the diaphragm is transmitted to the air, thereby generating a sound.

Various characteristics of an electroacoustic transducer, such as the sound pressure level, the frequency characteristics, and the conversion efficiency are varied in a complicate manner in accordance with, for example, the materials, part dimensions, assembly accuracies of a base member, a magnetic core, a diaphragm, and a magnet, etc. Particularly, variations in size of a gap between the tip end of the magnetic core and the diaphragm exert a large influence on the distribution of a magnetic field which acts on the diaphragm. Therefore, it is requested to perform a severe accuracy control on the gap size.

As a related technique of the conventional art, JP-B-63-22795U discloses an acoustic transducer in which a cylindrical case and a cylindrical permanent magnet are integrated into one unit, and the whole of the permanent magnet is completely embedded in a thick portion of the case, thereby enhancing the dimensional accuracy of the case. Particularly, FIG. 4 shows a configuration in which also a bottom plate is integrated with the case.

When the permanent magnet is embedded in the case, however, the distances between the permanent magnet and the bottom plate, and the permanent magnet and a diaphragm are inevitably increased. Therefore, the magnetic coupling between the components is impaired to increase the magnetic losses, thereby causing the conversion efficiency and the sound pressure level to be reduced.

### SUMMARY OF THE INVENTION

It is an object of the invention to provide an electroacoustic transducer in which positional accuracies of components can be remarkably improved, and which can attain a high efficiency and stable characteristics.

To achieve the above object, according to the invention, there is provided an electroacoustic transducer comprising:

a plate-like base member which is made of a magnetic material;

a magnetic core made of a magnetic material and upstanding on the base member;

a diaphragm made of a magnetic material and spaced from a tip end of the magnetic core by a gap;

a magnet which cooperates with the base member, the magnetic core, and the diaphragm to constitute a magnetic circuit, and which supplies a static magnetic field;

a coil which is placed around the magnetic core, and which supplies an oscillating magnetic field to the magnetic circuit; and

a housing member which is formed integrally with the base member and the magnet;

wherein the housing member is interposed between the base member and the magnet, a plan-view shape of the base member has a portion which elongates more outwardly than a width center of the magnet.

According to the invention, the housing member is interposed between the base member and the magnet, and hence the base member and the magnet are placed with being separated from each other. Even when the thickness of the magnet is varied, therefore, positional variations among components and internal stresses can be relaxed.

In the case where the base member and the magnet are placed so as to be close to each other, the magnetic coupling between them is improved. However, when the thickness of the magnet is insufficient, the gap between the magnet and the base member is increased, and when the thickness of the magnet is excessive, an undue force is applied to the components, thereby causing a possibility that the magnet is broken or the base member is deformed. When, as a countermeasure against this, the base member and the magnet are placed with being slightly separated from each other, it is possible to avoid adverse influences due to variations in thickness of the magnet.

When the plan-view shape of the base member has a portion which elongates more outwardly than a width center of the magnet, the magnetic coupling between the base member and the magnet is enhanced. Therefore, the magnetic loss due to the separate disposition of the two components can be compensated, and the conversion efficiency and the sound pressure level can be maintained at a high level.

Furthermore, the invention is characterized in that the plan-view shape of the base member remains to be inside an outer periphery of the magnet.

According to the invention, during a process of molding the housing member, the molding material can easily enter the gap between the base member and the magnet, so that the base member is hardly deformed. Therefore, the dimensional accuracy in the molding process can be remarkably improved.

When a plan-view shape in which the base member protrudes more outwardly than the outer periphery of the magnet is formed, the magnetic coupling between the base member and the magnet is further enhanced. During a process of molding the housing member, however, a resin can hardly enter the gap between the base member and the magnet, and the base member is easily deformed by the resin injection pressure. As a countermeasure against this, the plan-view shape of the base member is formed so as not to protrude from the outer periphery of the magnet, whereby deformation of the base member can be surely prevented from occurring.

Furthermore, the invention is characterized in that a step for supporting the diaphragm is formed on the housing member.

According to the invention, when a step for supporting the diaphragm is formed on the housing member, the accuracy of attaching the diaphragm to the housing member is improved. Therefore, the gap size between the diaphragm and the tip end of the magnetic core can be maintained with high accuracy.

### BRIEF DESCRIPTION OF THE DRAWINGS

FIG. 1 is an exploded perspective view showing an embodiment of the invention;

FIG. 2 is a plan view as seeing a housing 30 of FIG. 1 from the side of the upper face;

FIG. 3 is a bottom view as seeing the housing 30 of FIG. 1 from the side of the bottom face;

FIG. 4 is a section view of an electroacoustic transducer 1 taken along the line A-A of FIG. 2; and

FIGS. 5A to 5F are section views showing a step of insert molding the housing 30, in which FIGS. 5A to 5C show a comparative example, and FIGS. 5D to 5F show the embodiment.

### DETAILED DESCRIPTION OF THE PREFERRED EMBODIMENTS

Now, a description will be given in more detail of preferred embodiments of the invention with reference to the accompanying drawings.

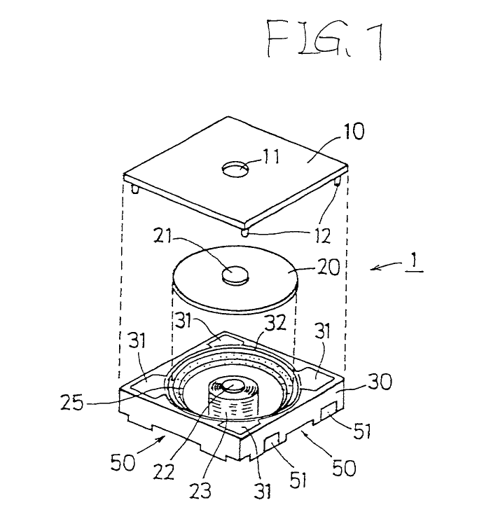

FIG. 1 is an exploded perspective view showing an embodiment of the invention. In an electroacoustic transducer 1, a top plate 10 having a sound hole 11 is fixed onto a box-like housing 30 configured by a flat rectangular cylindrical member. For example, the transducer has dimensions of a width of 7.5 mm×a depth of 7.5 mm×a height of 3 mm.

A columnar magnetic core 22 upstands from the center of the housing 30. A coil 23 is wound around the magnetic core 22. An annular magnet 25 is partly embedded in the inner wall of the housing 30 so as to be placed concentrical with the magnetic core 22. An annular inner space is ensured between the magnet 25 and the coil 23.

An annular step is formed on the upper face of the inner wall of the housing 30. A disk-like diaphragm 20 is horizontally placed on the annular step 32, thereby being positioned in place.

A recess 31 is formed in each of the edges of the upper face of the housing 30. Four protrusions 12 are formed in the edges of the lower face of the top plate 10, respectively. The attaching position of the top plate 10 is restricted by engagement between inner corners of the recesses recess 31 and the protrusions 12.

In a lower portion of the outer wall of the housing 30, four terminals 51 which are to be electrically connected to a circuit board by soldering or the like are disposed, and communication grooves 50 through which the inner space of the housing 30 communicates with the outside air are formed. The housing 30 and the top plate 10 are formed by a synthetic resin such as a thermoplastic resin.

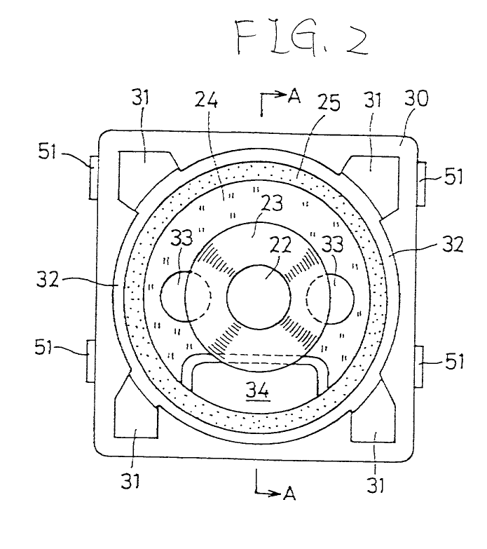

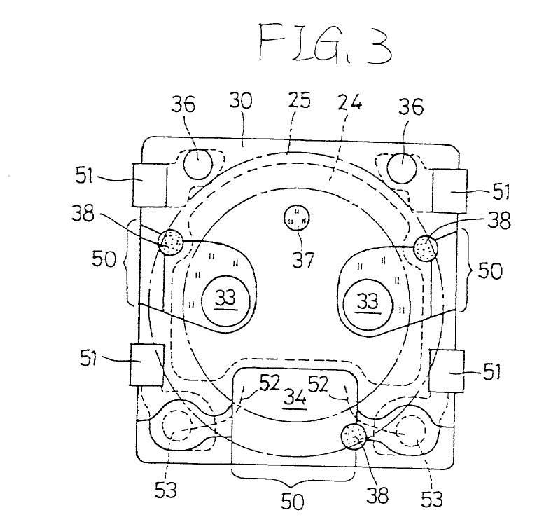

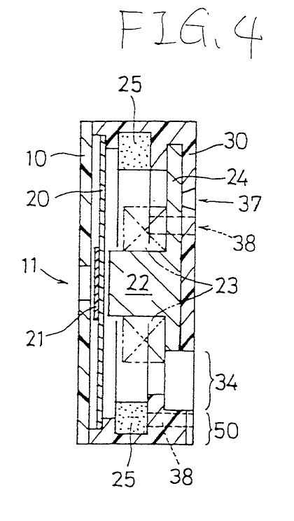

FIG. 2 is a plan view as seeing the housing 30 of FIG. 1 from the side of the upper face, FIG. 3 is a bottom view as seeing the housing 30 of FIG. 1 from the side of the bottom face, and FIG. 4 is a section view of the electroacoustic transducer 1 taken along the line A-A of FIG. 2.

First referring to FIG. 2, the annular step 32 which supports the diaphragm 20 is formed at a position which is slightly lower than the upper face of the housing 30, and the upper face of the annular magnet 25 is positioned at a level which is lower than the step 32. The coil 23 is placed around the magnetic core 22 at the center of the housing. The plate-like base 24 is placed below the magnetic core 22, the coil 23, and the magnet 25. The peripheral portion of the base 24 is partly embedded in the inner wall of the housing 30. In the vicinity of the outer periphery of the coil 23, communication holes 33 and 34 through which the annular inner space communicates with the outside are formed in the bottom plate of the housing 30 and the base 24.

Next referring to FIG. 3, the three communication grooves 50 are formed in positions which are slightly lower than the bottom face of the housing 30, respectively, so as to surround the communication holes 33 and 34. The communication grooves 50 elongates to a lower portion of the outer wall of the housing 30, so that the annular inner space of the housing 30 communicates with the outside. In the periphery of each of the communication holes 33, the base 24 is partly exposed.

A cutaway hole 37 is formed in the bottom face of the housing and at a position different from positions where the communication holes 33 are formed, whereby the base 24 is partly exposed.

The terminals 51 are partly embedded in the edges of the bottom face of the housing 30. The embedded portions of the upper two terminals 51 are partly exposed through cutaway holes 36, respectively. The lower two terminals 51 are halfway embedded in the housing 30, and exposed also in the vicinity of the communication hole 34. Lead wires 52 of the coil 23 are drawn out to the outside through the communication hole 34, and then electrically connected to the exposed portions of the lower two terminals 51 by soldering 53. Therefore, the lower two terminals 51 serve as terminals for supplying a driving signal to the coil 23, and the upper two terminals 51 serve as terminals for reinforcement.

In the bottom face of the housing, three cutaway holes 38 are formed so as to divide approximately equally the circumference of the magnet 25 into three portions, whereby the bottom face of the magnet 25 is partly exposed.

The plan-view shape of the base 24 has a portion which elongates more outwardly than the width center of the magnet 25, i.e., the intermediate radius Rc (=(Ra+Rb)/2) of the inner radius Ra and the outer radius Rb so that, as seeing from the side of the bottom face, the overlapping area between the bottom face of the magnet 25 and the base is increased as largely as possible while avoiding the terminals 51, the cutaway holes 38, and the communication hole 34. This shape of the base enhances the magnetic coupling between the base 24 and the magnet 25, so that the conversion efficiency and the sound pressure level can be maintained at a high level.

Next referring to FIG. 4, the base 24 which is made of a magnetic material is embedded in the inner bottom face of the housing 30, and the magnetic core 22 which is made of a magnetic material upstands on the base 24. Alternatively, the magnetic core 22 and the base 24 may be integrated with each other so as to be configured as a single pole-piece member.

The diaphragm 20 made of a magnetic material is supported at the peripheral edge portion by the upper face of the inner wall of the housing 30, and a constant gap is ensured between the center of the bottom face of the diaphragm 20 and the tip end of the magnetic core 22. A disk-like magnetic piece 21 is fixed to the center of the upper face of the diaphragm 20 so as to increase the mass of the diaphragm 20, thereby improving the efficiency of vibrating the air.

The magnet 25 is embedded in the inner wall of the housing 30 with being separated by a constant distance from the peripheral edge portion of the base 24. The magnet 25 is magnetized in the thickness direction. When the bottom face of the magnet 25 is magnetized to the N-pole and the upper face to the S-pole, for example, lines of magnetic force emerging from the bottom face of the magnet 25 pass through a route of the peripheral edge portion of the base 24 → a center portion of the base 24 → the magnetic core 22 → a center portion of the diaphragm 20 → a peripheral edge portion of the diaphragm 20 → the upper face of the magnet 25, so as to configure a closed magnetic circuit as a whole. The magnet 25 has a function of supplying a static magnetic field to the magnetic circuit. The diaphragm 20 is stably supported in a state where the diaphragm is attracted toward the magnetic core 22 and the magnet 25 by the static magnetic field.

When an electric oscillating signal is supplied from the circuit board to the coil 23 wound around the magnetic core 22 via the lower two terminals 51 and the lead wires 52, the coil supplies an oscillating magnetic field to the magnetic circuit. Then, the oscillating magnetic field is superimposed on the static magnetic field, whereby the diaphragm 20 is vibrated. As a result, the air on the side of the upper face of the diaphragm 20, and that on the side of the bottom face are vibrated.

The upper side of the diaphragm 20 cooperates with the top plate 10 to form a resonance chamber. When the vibration frequency of the diaphragm 20 substantially coincides with the resonance frequency of the resonance chamber, a sound of a high sound pressure level is generated, and the sound is emitted to the outside through the sound hole 11.

The sound which is generated on the bottom side of the diaphragm 20 is opposite in phase to the sound on the upper side of the diaphragm 20, and hence interference with the sound on the upper side must be suppressed as far as possible. To comply with this, the sound on the bottom side of the diaphragm 20 is emitted from the bottom face of the housing 30 to the outside via the annular inner space of the housing 30, the communication holes 33 and 34, and the communication grooves 50.

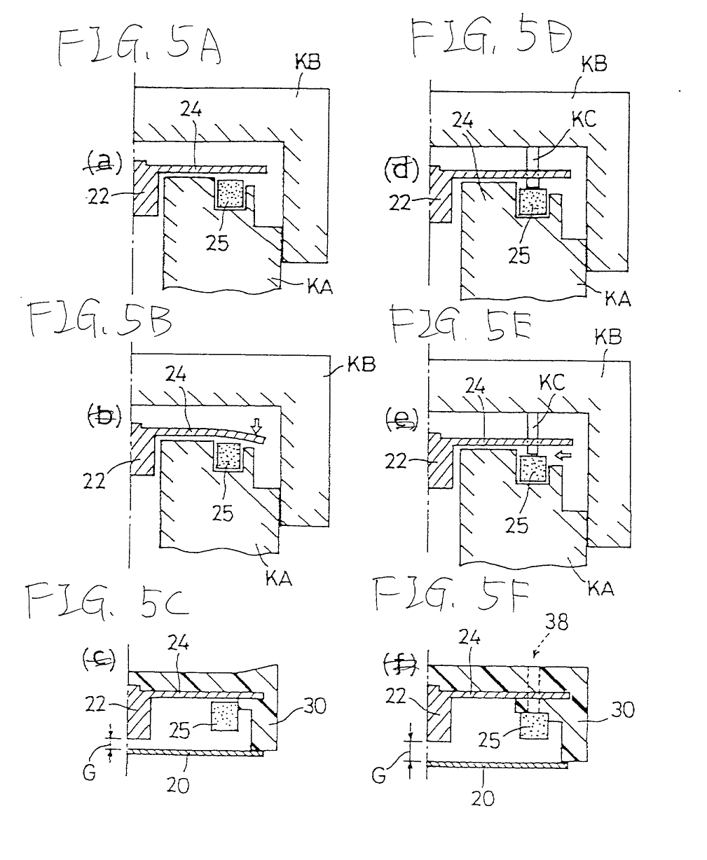

FIGS. 5A to 5F are section views showing a step of insert molding the housing 30, FIGS. 5A to 5C show a comparative example, and FIGS. 5D to 5F show the embodiment. First referring to FIG. 5A, the molding face of a molding die KA is shaped so as to correspond to the upper face and the inner wall of the housing 30, and that of a molding die KB is shaped so as to correspond to the outer wall of the housing 30. The shape of the space between the molding dies KA and KB corresponds to that of the housing 30.

The molding face of the molding die KA is formed into a shape which enables the magnetic core 22 and the base 24 to be positioned, and the non-magnetized magnet 25 to be positioned. The gap between the non-magnetized magnet 25 and the base 24 is set to be very small or about 0 to 0.08 mm. When the non-magnetized magnet 25 is made of a sintered material such as ferrite, the thickness tends to be substantially varied. Therefore, when the thickness of the magnet is insufficient, the gap between the magnet and the base 24 is increased. When the thickness of the magnet is excessive, the base 24 is pushed up, so that the magnet is broken or the base is deformed during the molding process.

Next referring to FIG. 5B, when a synthetic resin is injected into the mold space, the resin hardly enters the gap between the non-magnetized magnet 25 and the base 24 because of the viscosity of the resin. When the resin injection pressure presses the base 24 toward the magnet, the presence of the gap causes the base 24 to be deformed by a distance corresponding to the gap. The resin is then solidified under this state.

After the resin is solidified and the molding dies are removed, steps such as those of magnetizing the magnet 25, treating the coil lead wires 52, mounting the diaphragm 20, and attaching the top plate 10 are conducted to complete the electroacoustic transducer 1. Thereafter, the electroacoustic transducer 1 is mounted on the circuit board by solder reflow or the like. In this case, the stress of the base 24 is released by heating in the reflow, thereby causing so-called spring back. As shown in FIG. 5C, then, the outer peripheral portion of the housing 30 is warped toward the bottom face, and the step 32 which supports the diaphragm 20 is displaced toward the bottom face. As a result, the gap G between the diaphragm 20 and the magnetic core 22 is reduced to be smaller than a target value, and the characteristics of the electroacoustic transducer 1 are largely changed. The amount of the spring back mainly depends on the thickness of the magnet.

As a countermeasure against such spring back, as shown in FIG. 5D, press pins KC are disposed on the molding die KB to press the non-magnetized magnet in the direction from the base 24 to the molding die KA. In order to allow the resin to easily flow into the gap between the non-magnetized magnet 25 and the base 24, the gap is set to be relatively wide or about 0.4 mm.

Next referring to FIG. 5E, when the synthetic resin is injected into the mold space under this state, a sufficient amount of the synthetic resin flows also into the gap between the non-magnetized magnet 25 and the base 24, and hence the resin injection pressure is uniformly applied to both the faces of the base 24, thereby preventing the base 24 from being deformed. Since the non-magnetized magnet 25 is positioned by the press pins KC, it is possible to prevent the non-magnetized magnet 25 from being raised or displaced.

After the resin is solidified, the molding dies are removed. Then, steps such as those of magnetizing the magnet 25, treating the coil lead wires 52, mounting the diaphragm 20, and attaching the top plate 10 are conducted to complete the electroacoustic transducer 1 shown in FIG. 5F. As a result, even when the transducer is heated by solder reflow or the like, spring back does not occur because the residual stress of the base 24 is substantially zero. Therefore, the gap G between the diaphragm 20 and the magnetic core 22 coincides with the target value. Consequently, positional accuracies of the magnet 25, the base 24, and the other components can be remarkably improved, and characteristics of a final product can be stabilized.

When the structure in which the housing 30 is interposed between the magnet 25 and the base 24 is employed as described above, the base 24 is prevented from being deformed during the process of injecting the resin, and hence influences of spring back can be eliminated. As a result, positional accuracies among the components, particularly, the dimensional accuracy of the gap G between the diaphragm 20 and the magnetic core 22 can be maintained at a high level, and a high efficiency and stable characteristics can be obtained. Even when the thickness of the magnet is varied, a large influence is not exerted because the gap between the non-magnetized magnet 25 and the base 24 is wide.

Preferably, the plan-view shape of the base 24 remains to be inside the outer periphery of the magnet 25 as shown in FIG. 3, so as to have a shape which does not protrude from the outer periphery of the magnet toward the outside. According to this configuration, the resin can easily enter the gap between the magnet 25 and the base 24, so that deformation of the base 24 due to the resin injection pressure is prevented as far as possible from occurring, while ensuring a high magnetic coupling.

Preferably, the press pins KC are detachably disposed on the molding die. When the thickness of the magnet is changed to another value in accordance with specifications of a final product, this change can be coped with by replacing the pins with other press pins of a different restricting position.

As shown in FIGS. 3 and 4, cavities of the press pins KC are formed as the cutaway holes 38. Furthermore, also press pins which are to be used for positioning the base 24 and the upper two terminals 51 in the step of insert molding the housing 30 may be disposed on the die. The cavities of these press pins are formed as the cutaway holes 36 and 37.

Since the magnet 25, the base 24, and the terminals 51 are partly exposed through the cutaway holes 36 to 38, there arises an advantage that quality management such as positioning of the components, and measurement of the positions can be easily conducted in steps of assembling and checking the electroacoustic transducer.

The cutaway holes 36 to 38 may remain as they are. In this case, no problem will be produced in operation. Alternatively, a step of filling the cutaway holes 36 to 38 with a filler such as a synthetic resin (preferably, the same material as that of the housing 30) may be added. In the alternative, characteristics of a final product such as air tightness and durability can be improved.

In the above, an example in which a non-magnetized magnet is used as the magnet that is to be inserted during a process of molding the housing has been described. Alternatively, in the case where molding dies made of a non-magnetic material such as aluminum are used, a magnetized magnet may be used.

As described above in detail, according to the invention, the housing member is interposed between the base member and the magnet, and hence the base member and the magnet are placed with being separated from each other. Even when the thickness of the magnet is varied, therefore, positional variations among components and internal stresses can be relaxed.

When the plan-view shape of the base member has a portion which elongates more outwardly than a width center of the magnet, the magnetic coupling between the base member and the magnet is enhanced. Therefore, the magnetic loss due to the separate disposition of the two components can be compensated, and the conversion efficiency and the sound pressure level can be maintained at a high level.

Furthermore, the plan-view shape of the base member remains to be inside an outer periphery of the magnet. According to this configuration, during a process of molding the housing member, the molding material can easily enter the gap between the base member and the magnet, so that the base member is hardly deformed. Therefore, the dimensional accuracy in the molding process can be remarkably improved.

What is claimed is:

1. An electroacoustic transducer comprising:
a plate-like base member which is made of a magnetic material;
a magnetic core made of a magnetic material and upstanding on said base member;
a diaphragm made of a magnetic material and spaced from a tip end of said magnetic core;
a magnet which cooperates with said base member, said magnetic core and said diaphragm to constitute a magnetic circuit, and which supplies a static magnetic field;
a coil which is placed around said magnetic core, and which supplies an oscillating magnetic field to said magnetic circuit; and
a housing member formed integrally with said base member and said magnet;
wherein said housing member is interposed between said base member and said magnet, a plan-view shape of said base member has a portion which elongates more outwardly than a width center of said magnet.

2. The electroacoustic transducer according to claim 1, wherein the plan-view shape of said base member remains to be inside an outer periphery of said magnet.

3. The electroacoustic transducer according to claim 1, wherein a step for supporting said diaphragm is formed on said housing member.
